(19) United States
(12) Patent Application Publication
(10) Pub. No.: US 2024/0198457 A1
(43) Pub. Date: Jun. 20, 2024

(54) HIGH THROUGHPUT SYSTEM FOR PRECISION COMPOSITE PANEL PROCESSING

(71) Applicant: JLK Technology Pte Ltd, Singapore (SG)

(72) Inventors: Sia Nguan Eugene TAN, Singapore (SG); Song Tao LI, Dongguan (CN)

(21) Appl. No.: 18/067,252

(22) Filed: Dec. 16, 2022

(51) Int. Cl. B23K 26/38; B23K 26/402

(52) U.S. Cl. CPC B23K 26/38; B23K 26/402

(57) ABSTRACT

A system for cutting composite sheets from a composite panel in a high throughout manner is disclosed. The system comprises a platform; a displacement module; a cutting module located for slicing a plurality of the composite sheets from the composite panel, by way of heating the composite panel at specific locations using a laser beam generated from a laser, each composite sheet having a contour profile; a placing module for picking a number of the sliced composite sheets and arranging the picked composite sheets onto one of multiple inspection slots located on a rotary surface; and an inspection module comprising at least two cameras each being enabled to capture a digital image of the contour profile of at least one composite sheet at one of the inspection spots and a computing device to process the digital image for a computing device to analyse the contour profile using a set of predefined parameters. Preferably, the laser is an ultrashort pulse laser capable of emitting ultrashort pulses of light in an order of picosecond.

### TECHNICAL FIELD

The present disclosure relates to a high throughput system for preparing great number of composite sheets from a composite panel within a period of time. In more specific, the system utilizes laser heating for slicing or cutting the composite sheets out from the composite panel with sufficient air flow being provided constantly to avoid heating from damaging the compositing sheet produced thereby. The system also possesses multiple inspection points to cope with the high throughput of the composite sheets.

### BACKGROUND

Utilizing laser beam for rapidly creating a line or multiple heated zones on an item of interest for splitting the item into a preferred dimension or shape has been disclosed for over 50 years. For instance, U.S. Pat. No. 3,453,097 teaches about cutting a transparent glass by repetitively sweeping a laser beam along a line predefined on the glass surface that the glass surface is tinted to increase the radiation absorption. Similar teachings can be found on U.S. Pat. No. 3,885,943 disclosing the idea to preheat both upper and lower surfaces of the glass to a temperature of 1000° F. to 1250° F. such that the vaporization rate is faster than the feeding rate of adjacent glass into the space vacated by glass vaporization. Despite its applicability, laser cutting was far from a perfect solution for splitting brittle materials such as glasses during the early stage of development. Particularly, the cutting or slicing process is generally slow that attaining a high throughput seems to be difficult. Furthermore, the cutting process tends to produce microcracks or contaminates which cause defects in the products yielded. Additional steps may be taken to polish the edge of the products to remove microcracks created. Nevertheless, effort has been put in place to at least overcome or resolve some of the aforesaid shortcomings of laser cutting. For example, U.S. Pat. No. 7,173,212 discloses that the problems about microcracking can be mitigated by modifying surface of the items, such as semiconductor or glasses, to be cut using multiple rays of laser beam of different energy. Likewise, Karube et al. discloses another way to reduce deficiency in the fragile materials scribed by low energy laser in United States patent publication no. US20070062921 that the absorption coefficient of the material is controlled within a calculated range throughout the scribing process. Despite these improvements, the use of laser cutting or scribing are generally restricted to glass, quartz or semiconductor (so-called fragile materials) in the field. There are lack of disclosures in the field regarding using the laser scribing or cutting technology for processing composite such as laminates composed of multiple layers of different materials. Subjecting laminates of different materials especially plastics in laser cutting can be a great challenge considering various thermal properties involved that each material may have melting or vaporizing point different from others. Separating one material by laser heating may somehow causes damage on other materials of the same laminates. Therefore, there exits a need to develop a system and/or method applicable to slice multiple composite sheets out of a composite panel of much larger in size in a high throughput fashion.

### SUMMARY

The present disclosure aims to provide a system for slicing or cutting multiple composite sheets out from a composite panel in a fully automated and high throughput fashion. Particularly, the disclosed system utilizes high pulse laser beam to work on a composite panel for slicing multiple copies of composite sheets of a preferred shape and dimension therefrom in a working sequence as programmed to a computing device or module installed to the disclosed system in a high throughput manner.

Another object of the present disclosure is to offer a composite sheets cutting system equipped with inspection module or subsystem. The inspection module is configured to recognize any predefined deficiencies and/or damage found on the sliced composite sheets that the inspection module subsequently analyses the extend of the damage to compared against a predetermined threshold. The inspection module further discards the sliced composite sheets carrying damages exceeding the predetermined threshold.

Still another object of the present disclosure is to provide a composite sheet cutting system capable of computing and compensating positional and/or angular deviations in association to the composite panel loaded onto the displacement module for being processed by the cutting module based upon a sensor installed to the disclosed system to attain high throughput of the composite sheet production.

At least one of the preceding objects is met, in whole or in part, by the present disclosure, in which one of the embodiment of the present disclosure is a system for cutting composite sheets from a composite panel comprising a platform defined by a top, a bottom and sidewalls; a displacement module on the top of the platform, the displacement module comprising (i) a holder for retaining an uncut composite panel and a primary actuator arranged on the platform engaging to the holder in a manner facilitating transfer of the holder along with the retained panel, and (ii) at least a pair of slicing trays each with a planar surface for receiving the composite panel transferred thereto by the holder and a secondary track engaging to the pair of slicing trays; a cutting module located on the platform for slicing a plurality of the composite sheets from the composite panel, which is kept within the slicing tray, by way of heating the composite panel at specific locations using a laser beam generated from a laser which moves on top of the composite panel at a predetermined fashion in multiple working sequence, each moving sequence of the laser being configured to slice N copy of the composite sheet, each composite sheet having a contour profile. Preferably, the laser is an ultrashort pulse laser capable of emitting ultrashort pulses of light in an order of picosecond. Also, the composite panel is a laminate comprising at least a polyethylene layer, an electroplated layer, and a conductive metal layer with the electroplated layer sandwiching in between the polyethylene layer and the conductive metal layer.

For more embodiments, the disclosed system may further comprises a placing module comprising a first robotic arm and a second robotic arm being configured to pick a Y number of the sliced composite sheets from the slicing tray and arrange each of the picked composite sheets onto one of multiple inspection slots located on a rotary surface; and an inspection module comprising a P number of cameras each being enabled to respectively capture a digital image comprising the contour profile of at least one composite sheet at one of the inspection slots and a computing device to process the digital image for a computing device to analyse the contour profile using a set of predefined parameters, the second robotic arm being configured to collect the composite sheets meeting the parameter. Accordingly, Y and P are more than one.

For some embodiments, the Y number of the sliced composite sheets placed in the inspection slots are divided into P number of zones that digital image of composite sheets of each divided zone is captured respectively by one of the P number of cameras.

For some embodiments, the cameras are spaced apart and suspended on top of the rotary surface that the rotary surface rotates to align each divided zone with the corresponding camera for capturing digital image in a stepwise fashion.

In more embodiments, the disclosed system further comprises a loading bay for housing multiple composite panels arranged in stack that these stacked composite panels are to be processed by the system one by one to produce the composite sheets.

In further embodiments, the disclosed system further comprises an alignment module having a slab being configured to receive the composite panel from the loading bay through the holder and align the received composite panel thereby in accordance with a predetermined setting. Preferably, the slab is slant towards an angle along with the composite panel for aligning the composite panel in accordance with the predetermined setting.

For some embodiments, the disclosed system further comprises a first sensor to detect and read at least a code carried on the composite panel that the holder moves a topmost composite panel from the stack in the loading bay to the slab upon verification of the code by the computing device. The code is associated with information regarding qualitative measurements of the composite panel.

Preferably, in some embodiments, the slicing tray carries a plurality of apertures on the planar surface of the slicing tray with a constant flow of negative air pressure generated such that a suction force is created to pull the sliced composite sheets towards the planar surface and/or cool the composite panel rested on the slicing tray. More preferably, the suction force removes debris produced from the slicing of the composite sheets by the laser through the plurality of apertures.

According to a number of preferred embodiments, the cutting module further comprises a secondary sensor capable of capturing or recognizing N number of individual fiducial marker, each for a composite sheet, on the composite panel that the computing device computes positional and angular compensation associated to the working sequence in moving the laser for slicing the composite sheets based upon the recognized N number of individual fiducial marker. More preferably, the N ranges between 10 to 30.

For some embodiments, the N number of individual fiducial marker or the manner the individual fiducial marker to be captured is determined by the code read or detected by the primary sensor.

For some embodiments, the pair of slicing trays have one of the slicing trays subjected to heating for slicing the composite sheets while another slicing tray subjected the sliced composite sheets to picking by the robotic arms.

For more embodiments, the parameter comprises surface area of the available burn mark on the composite sheet, physical dimension of the composite sheet and/or ratio of surface area on the composite sheet contaminated by debris produced during the heating.

In a number of the embodiments, the laser is moved at a speed of 100 mm/s to 1500 mm/s.

In some embodiments, the holder is configured to place a cover plate onto the composite panel prior to slicing of the composite panel that the laser beam scribe through the cover plate along with the underneath composite panel to produce the composite sheets. The cover plate is preferably made of metal or polymers of high density that the cover plate is used to flatten the composite panel through its weight under certain circumstances.

### BRIEF DESCRIPTION OF THE DRAWINGS

FIG. 1 is a perspective view of parts of one embodiment of the disclosed system;

FIG. 2 is a top view of the embodiment illustrated in FIG. 1;

FIG. 3 is a top view of one embodiment of the stacking tote tray used in the loading bay for stacking the composite panels;

FIG. 4 shows (a) one embodiment of the composite sheets and (b) a cross-sectional view of the composite sheet revealing various layers;

FIG. 5 is a perspective view of one of the slicing trays and part of the secondary actuator of one embodiment of the disclosed system;

FIG. 6 is a perspective view of one embodiment of the cutting module (without external casing) used in the disclosed system;

FIG. 7 is a top with of the disclosed system illustrating relative orientation of the robotic arms and the inspection slots on the rotary surface; and

FIG. 8 is a perspective view of part of the inspection module including the pair of cameras and the inspection slots located on the rotary surface.

### DETAILED DESCRIPTION

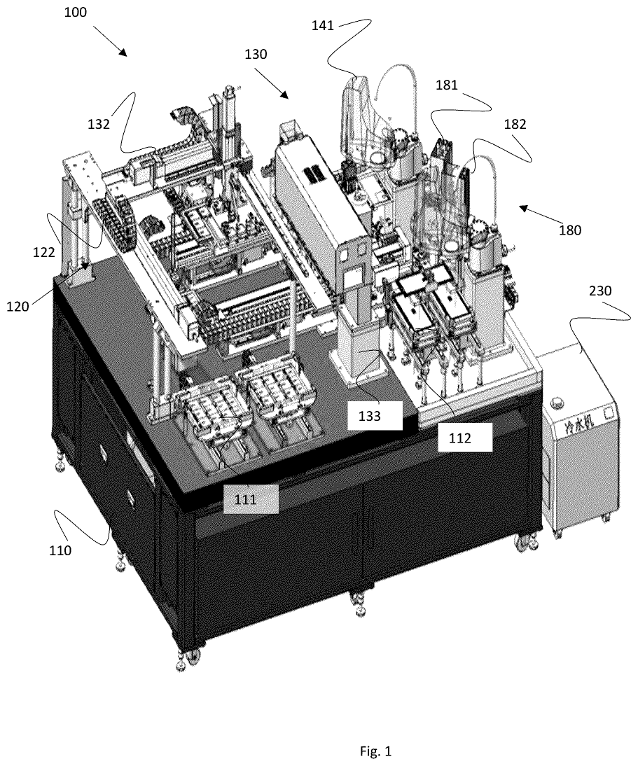

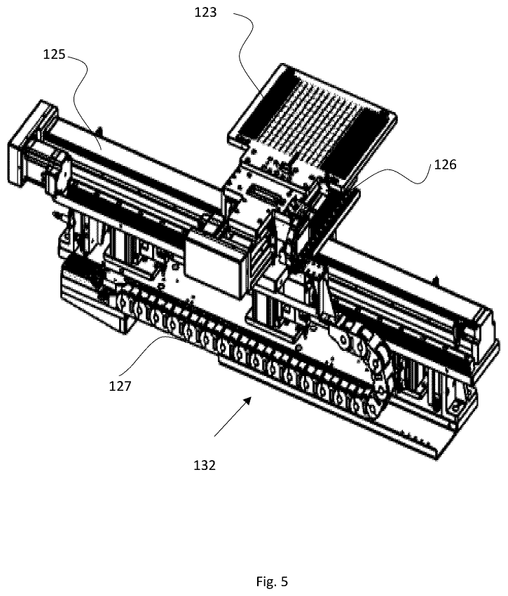

The presently preferred embodiments of the present disclosure will be best understood by reference to the drawings, wherein like parts are designated by numerals throughout. It will be readily understood that the components of the present disclosure, as generally described and illustrated in the figures herein, could be arranged and designed in a wide variety different configuration. Thus, the following more detailed description of the embodiments of the composite sheet cutting or preparing system of the present disclosure, as represented in FIG. 1 through FIG. 6, is not intended to limit the scope of the disclosure as claimed but is merely representative of presently preferred embodiments of the present disclosure.

The directional term such as “top”, “bottom”, “parallel”, “side” and “perpendicular” and “proximal” used throughout herein the specification generally refers to the relative direction of the described embodiments with regard to the manner which the disclosed system being positioned and operated to produce the composite sheet under normal circumstances.

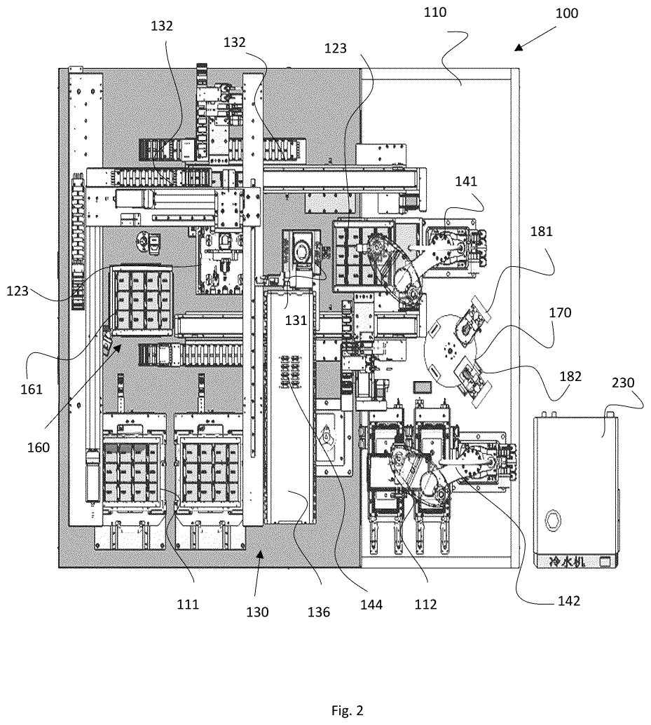

FIG. 1 and FIG. 2 illustrate one embodiment of the disclosed system (100) for slicing, cutting and/or preparation of multiple composite sheets (200) from a composite panel of larger size, compared to the composite sheets (200) derived thereof. In general, the disclosed system (100) for cutting composite sheets (200) from a composite panel comprises a platform (110) defined by a top, a bottom and sidewalls; a displacement module on the top of the platform (110), the displacement module comprising (i) a holder (not shown) for retaining an uncut composite panel and a primary actuator (122) arranged on the platform (110) engaging to the holder in a manner facilitating transfer of the holder along with the retained panel, and (ii) at least a pair of slicing trays (123) each with a planar surface for receiving the composite panel transferred thereto by the holder and a secondary actuator (132) engaging to the pair of slicing trays (123); a cutting module (130) located on the platform (110) for slicing a plurality of the composite sheets (200) from the composite panel, which is kept within the slicing tray (123), by way of heating the composite panel at specific locations using a laser beam generated from a laser (131) which moves on top of the composite panel at a predetermined fashion in at least one working sequence that each working sequence of the laser (131) is configured to slice N copy of the composite sheet (200) with each composite sheet (200) having a contour profile. In some embodiments, the disclosed system further comprises a placing module (140) comprising a first robotic arm (141) and second robotic arm (142) being configured to pick a Y number of the sliced composite sheets (200) from the slicing tray (123) and arrange each of the picked composite sheets (200) onto one of multiple inspection slots (184) located on a rotary surface (170); and an inspection module (180) comprising a P number of cameras each being enabled to respectively capture a digital image comprising the contour profile of at least one composite sheet (200) at one of the inspection slots (184) and a computing device to process the digital image for a computing device to analyse the contour profile using a set of predefined parameters, the first (141) and the second robotic arms (142) being configured to collect the composite sheets (200) meeting the parameter. Preferably, Y and P are integers more than one. More preferably, the Y number of the sliced composite sheets (200) placed in the inspection slots (184) are divided into P number of zones that digital image of composite sheets (200) of each divided zone is captured respectively by one of the P number of cameras.

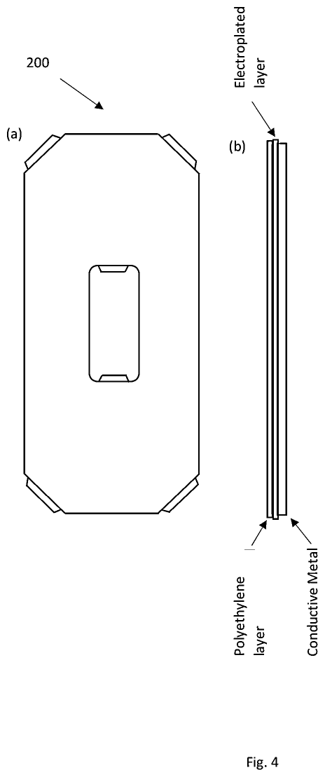

It is important to note that the composite panel and the produced composite sheet (200) are laminates. Preferably, the laminate comprises at least a polyethylene layer (201), a electroplated layer (202), and a conductive metal layer (203) with the electroplated layer (202) sandwiching in between the polyethylene layer (201) and the conductive metal layer (203). The conductive metal layer may be prepared from copper, aluminium, silver, gold, etc. For some embodiments, each layer of the laminate may have irregular thickness throughout the composite panel so that the composite sheets (200) produced have the desire contour profile as in an example illustrated in FIG. 4. The polyethylene layer (201), the electroplated layer (202) and/or the conductive metal layer (203) may carry a preferred surface configuration before being joined to form the laminate of the composite panel. The way which the laser cut or slice the composite panel may associate to the surface configuration of at least one layer of the laminate such that the produced composite sheet (200) possesses one or more desired features. For instance, in some embodiments, the disclosed system (100) may slice the composite panel according to a surface configuration of the layers of the laminate that the produced composite sheets (200) exhibit vibration dampening property. Despite the uneven thickness or surface configuration created at specific locations of one or more layers of the composite panel, the polyethylene layer (201), the electroplated layer (202) and the conductive metal layer (203) are generally prepared in a thickness ratio of 3-5:3-5:8-15 to prevent the slicing or cutting from the laser (131) free from substantial damages. Further, the composite panel is preferably in a shape of square or rectangular to facilitate alignment for being transported and/or processed by various modules of the disclosed system (100)

As shown in FIG. 1, the platform (110) of the disclosed system (100) serves to support installation or establishment of other modules and components of the disclosed system (100) on its top. The top of the platform (110) allows other modules like displacement module (120), cutting module (130), placing module (140) and/or the inspection module (180) to be anchored or secured to the platform (110) for the system (100) to process the composite panels and composite sheets (200). Nevertheless, it is possible to have some of the modules like the inspection module (180) constructed at the side of the platform (110) instead of the top of the platform (110). Moreover, an enclosure may be defined within the platform (110) for storage purposes and/or concealing the wires effectuating electrical communication of various modules including the computing device. The enclosure may be used to temporarily store unprocessed composite panels before being loaded in batch for slicing. Preferably, the enclosure defined within the platform (110) can be accessible through a lockable door (117) installed on the sidewalls (115). In some preferred embodiments, a transparent hood made of glass, acrylic or the like materials are erected on the top of the platform (110) around the perimeter to substantially encompass all the modules established on top of the platform (110) inside the hood. The hood preferably seals off the modules secure on top of the platform (110) to prevent contamination of the composite sheets (200) produced while preventing escape of the fume, which is generated along with the heating of the composite sheet (200), to an environment external to the disclosed system (100). The transparency of the hood permits the slicing process running inside the hood to be visible by the operator of the disclosed system (100) in case overheating or accidental burning of the composite panel can be possibly detected earlier by the operator before a corresponding alarm is released by the disclosed system (100) notifying the operator.

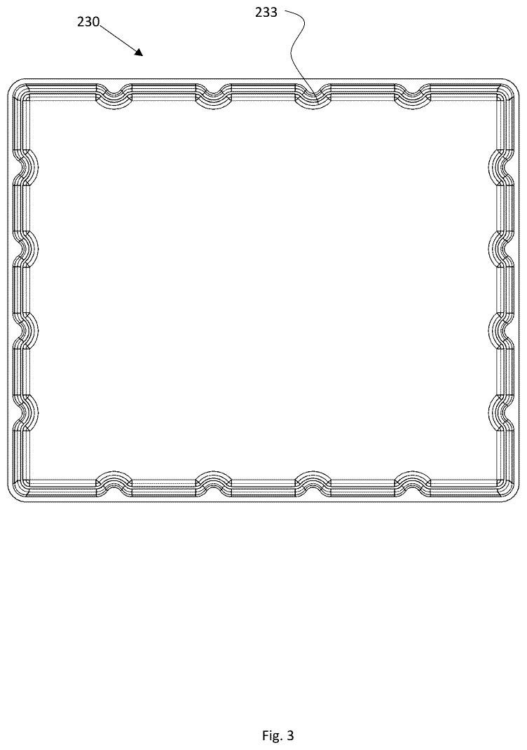

According to some preferred embodiments, the disclosed system (100) may be constructed with a loading bay (111) for housing or depositing multiple composite panels arranged in stack. Each composite panel may be firstly placed in a tote tray (230) as shown in FIG. 3 followed by piling the tote trays (230) keeping the composite panel in stack at the loading bay. The tote tray (230) is fabricated with evenly or almost evenly spaced protuberances (233) on the internal surface of the sidewalls of the tote tray (230) to abut on the side edge of the composite pane accommodated thereto for better securement of the composite panel. Also, in more embodiments, the disclosed system (100) may have an unloading bay (112) located proximate to the loading bay (111) on one side or on the same side of the platform (110) to facilitate deposit of the uncut composite panel and/or collection of the sliced composite panel (or whatever leftover). Particularly, the displacement module (120) grabs the composite panel out from tote tray (230) for being processed by other downstream modules. Then, the unoccupied tote tray (230) is swapped to the unloading bay (112), preferably by a mechanical pusher of the displacement module (120). The unoccupied tote trays (230) are preferably organized in stack as well for collection at the unloading bay. In few embodiments, the unoccupied tote tray (230) may be configured to receive the sliced or processed composite panel for being collected by the operator subsequently. More specifically, the displacement module (120) places a processed composite panel into the topmost tote tray (230), which is unoccupied, stacked at the unloading bay (112) before putting on another unoccupied tote tray (230) thereupon from the loading bay (111). In line with the loading (111) and unloading bay (112) found on the disclosed system (100), the hood may comprise a corresponding opening and lockable cover. The opening fabricated on the hood grant the operator to access the loading (111) and unloading bay (112) to respectively deposit the collect the tote trays (230).

Pursuant to more embodiments, the disclosed system (100) may further comprise an alignment module (160). In more specific, the alignment module (160) serves to condition the composite panel towards the precise orientation prior to depositing the composite panel onto the slicing tray (123) for cutting the composite sheets (200) out of the composite panels. The alignment module (160) comprises a slab (161) with raised sidewalls at least at two perpendicular connecting edges. The slab (161) is configured to receive the composite panel from the loading bay (111) through the holder and align the received composite panel thereby in accordance with a predetermined setting. Preferably, in some embodiments, a corner of the slab (161) with the erected sidewalls is slanted towards an angle along with the composite panel for aligning the composite panel in accordance with the predetermined setting. The bottom planar surface of the slab (161) can be connected to one or more robotic pushers to effectuate slanting of the slab (161) and reverting the slab (161) to its original orientation for subsequent aligning action. For some embodiment, the disclosed system (100) is equipped with a first sensor to assist the disclosed system (100) to align the composite panel in a more effective way. Specifically, the first sensor detects and reads at least a code carried on the composite panel and communicates the code to the computing device prior to depositing the composite panel onto the slab (161). The code is associated with information regarding qualitative measurements and/or properties of the composite panel. With the aid of the code and the first sensor, the computing device instructs the alignment module (160) to tilt the slab (161) according to the predetermined setting associated therewith. Also, in some embodiments, the holder moves a topmost composite panel from the stacked tote trays (230) in the loading bay (111) to the slab (161) upon verification of the code by the computing device.

As described in the foregoing, the displacement module (120) comprises the holder coupled to the primary actuator (122) while the at least pair of slicing trays (123) engaged to the secondary actuator (132). More specifically, the holder is a suction arm that a suction force or a combined suction force is generated to adequately lift and move the composite panel from the tote tray (230) at the loading bay to the slab (161) of the alignment module (160) then to at least one of the slicing trays (123). The disclosed system (100) has the holder overhang in the air within the hood above the tote trays (230), the slicing trays (123) and the slab (161). The holder preferably connects to one or more cable drag chains, in which one or more hydraulic lines mays be resided to drive both vertical and horizontal movement of the holder for lifting and moving the composite panel in the air within the hood. The hydraulic lines can be considered part of the primary actuator (122) effectuating the movement of the holder. Data and power cables are housed inside the cable drag chain as well for communication with the computing device and driving movement of the holder. The holder may firstly grasp the composite panel out from the topmost tote tray (230) then placing the grasped composite panel onto the slab (161) for alignment. Once the alignment process has been completed, the holder picks up the aligned composite panel and places it onto at least one of the slicing trays (123) for cutting.

It is crucial to retain the composite panel at the preferred position and orientation within the slicing tray (123) as any slight deviation, possibly caused by vibration in association of the movements of different modules, even in the scale of micrometre will lead to production of damaged or defective composite sheet (200). To better securement of the composite panel, the slicing tray (123) carries a plurality of apertures on the planar surface of the slicing tray (123) with a constant flow of negative air pressure generated. The negative air pressure results in a suction force thereby pulling towards the slicing tray (123). Likewise, the suction force also pulls or draws the sliced composite sheets (200) towards the planar surface. The air flow running on the planar top surface of the slicing tray (123) also cools the conductive metal layer (203) of the composite panel resting thereto to a temperature sufficient to resist potential heat damage caused by the incoming laser beam. The cooling effect likewise applies to the sliced composite sheets (200) drawn towards the slicing tray (123) upon completing of the working sequence separating the composite sheets (200) from the composite panel. Still, the suction force removes debris produced from the slicing of the composite sheets (200) by the laser (131) through the plurality of apertures. Particularly, the surface of the composite panel or sheets may carry microstructures such as grooves, slots, etc. on the planar surface that filing of the debris into these microstructures can give rise to defective composite sheet (200) with reduced performance. Once the slicing or cutting becomes completed, the displacement module (120) subjects the slicing tray (123) containing the sliced composite sheets (200) for being picked and transferred by the placing module (140) to the inspection module (180) for defects inspection then further subjects the slicing tray (123) (empty or unoccupied) to receive an uncut composite panel transferred from the alignment module (160). When the slicing tray (123) with the sliced composite is being processed by the placing module (140), the disclosed system (100) directs another tray (123) keeping the unprocessed or uncut composite panel under the laser (131) for slicing. By rotating the pair of slicing trays (123) in between the cutting module (130) and the placing module (140), the disclosed system (100) is able to optimize the number of working sequences performed at the cutting module (130) while the rate of inspection at the inspection module (180) is tuned to be compatible with the rate of composite sheets (200) being prepared at the cutting module (130). The secondary actuator (132) of the disclosed system (100) is similar to or almost similar to the primary actuator (122), which is assembled from different components to effectuate the horizontal and/or vertical movement. Particularly, the secondary actuator (132) comprises a first longitudinal track (125), a second longitudinal track (126) with one end moveably attached to a body of the first track (125) in perpendicular direction, and at least a hydraulic power line. The second track (126) can be slidably move along the body of the first track (125). The slicing tray (123) has a bracket extending from an edge to moveably mount on the second track (126). The mountings of the tray (123) onto the second track (126) and indirectly onto the first track (125) respectively facilitate movement of the tray (123) along the X-axis and Y-axis. Movement of bracket on the second track (126) or the second track (126) on the body of the first track (125) can be realized by the one or more hydraulic power lines, which in fact may be house in a cable drag chain (127) for protection. Other type cables such as data cable, electrical power cable, etc. can be resided within the cable drag chains (127) too. The mechanical components assembled for the secondary actuator (132) is similar to or almost similar to the arrangement of the primary actuator (122) in a number of the disclosed embodiments. It is possible to connect an electrical or hydraulic power line to one end of the first track for lifting or moving the slicing tray (123) vertically along the Z-axis, in some embodiments of the disclosed system (100).

Pursuant to a number of the preferred embodiments, the pair of slicing trays (123) of the disclosed system (100) have one of the slicing trays (123) subjected to heating for slicing the composite sheets (200) while another slicing tray (123) subjected the sliced composite sheets (200) to picking by the robotic arms (141 and 142).

To improve precision of the slicing or cutting of the composite panel, the cutting module (130) further comprises a secondary sensor (not shown) capable of capturing or recognizing N number of individual fiducial marker or point, each for a composite sheet (200), on the composite panel that the computing device computes positional and angular compensation associated to the working sequence in moving the laser (131) for slicing the composite sheets (200) based upon the recognized N number of individual fiducial marker. In more specific, the second sensor can be one or more camera, preferably hi-resolution auxiliary camera, to capture one or more clear image covering an area on the composite panel to be scribed or heated by the laser beam in a corresponding working sequence. For example, the auxiliary camera checks blue fiducial markers on the composite panel to determine centre of each part on the composite panel to be cut forming a composite sheet thereto. The captured image of the fiducial markers is transmitted to the computing device for analysis such that a scribing path or heating path or irradiation path of the laser beam of the working sequence can be computed, formulated or verified by the computing device. The computing device can make adjustment to the scribing path or heating path or irradiation path to be implemented in case deviation regarding position or orientation of the composite panel to cut is detected based on the high-resolution image received. Particularly, the laser (131) is adjusted to perform positional compensation throughout the scribing path. For more embodiments, the computing device may move or tilt the laser (131) around the vertical and/or horizontal axis to attain the positional and/or angular compensation. Further, the number of the fiducial marker ranges from 2 to 50. The time needed for the computing device to analyse all the fiducial markers involved in a working sequence can be the limiting factor for the total number, N, of the composite sheets (200) obtainable from a working sequence. By increasing the value of N, more fiducial marker, images and data has to be processed by the computing device thus more time will be required for the computing device to verify or formulate the scribing path resulting in stalling of the laser (131) to work on the composite panel. Inventors of the present disclosure found that it is critical to balance the number, N, of composite sheets (200) produced and the time required for formulating or verifying the scribing path by the computer device. Preferably, N shall range between 10 to 30. More preferably, N shall range between 10 to 25.

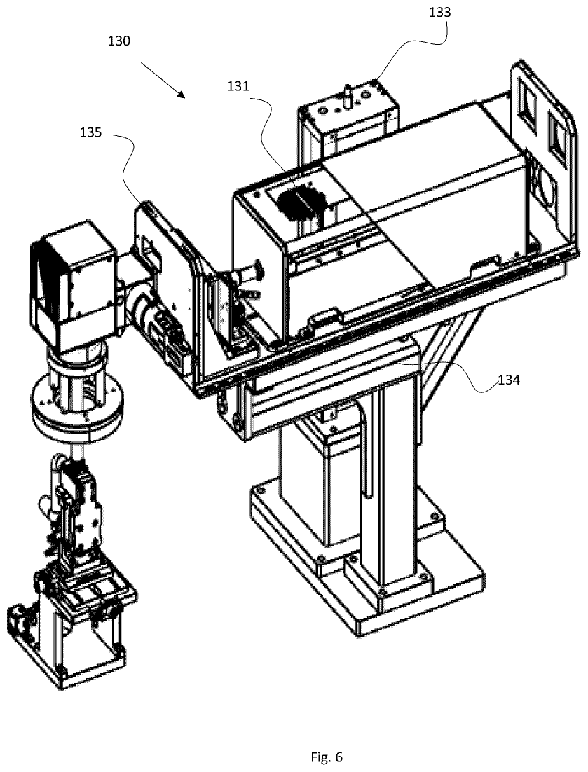

FIG. 6 illustrates an embodiment of the laser (131) employed in the disclosed system (100). Preferably, the laser (131) is an ultrashort pulse laser capable of emitting ultrashort pulses of light in an order of picosecond. In order to drive the laser (131) and the discharged laser beam corresponding to the verified and/or computed scribing path of a working sequence, the laser (131) may mechanically attach to a third actuator (138). In several embodiments, the third actuator (138) comprises a vertical pole (133), a longitudinal first bridge (134) perpendicularly mounting onto a body of the pole (133) through a mounting piece, a longitudinal second bridge (135) mounting on top of the first bridge (134), and at least a hydraulic or electrical power line for driving movement of the first bridge (134) and second bridge (135). The first bridge (134) has one end attached to the pole (133). In general, connection of the first bridge (134), the second bridge (135) and the mounting piece enables 3-dimensional movements of the laser (131) for fulfilling the scribing path or heating path on the composite panel. The pole (134), the first bridge (135) and the second bridge (136) may contain a void space within such that wiring can be run inside the void space in some embodiments. Likewise, one or more cable drag chains can be employed to effectuate the movement along with the bridges (135 and 136) and pole (134). The disclosed system (100) guides a cooling medium from a storage tank (230) into the void space of the second bridge (136), in which the laser source is housed. The cooling medium ensures the laser source free from overheating throughout the slicing of the composite panel. A storage of the cooling medium can be positioned around the platform (110). Holes (144) are fabricated on the external casing of the second bridge (136) to render heat dissipation easier from the laser source. As in the setting forth, it is important to attain high throughput about the production of the composite sheets (200) while maintain the damage caused by the laser heating at the minimal. It was found by the inventors of the present disclosure that the laser (131) is moved at a speed of 100 mm/s to 1500 mm/s throughout the scribing path of a working sequence for achieving the desired production rate with minimal or almost minimal defective composite sheets (200) yielded.

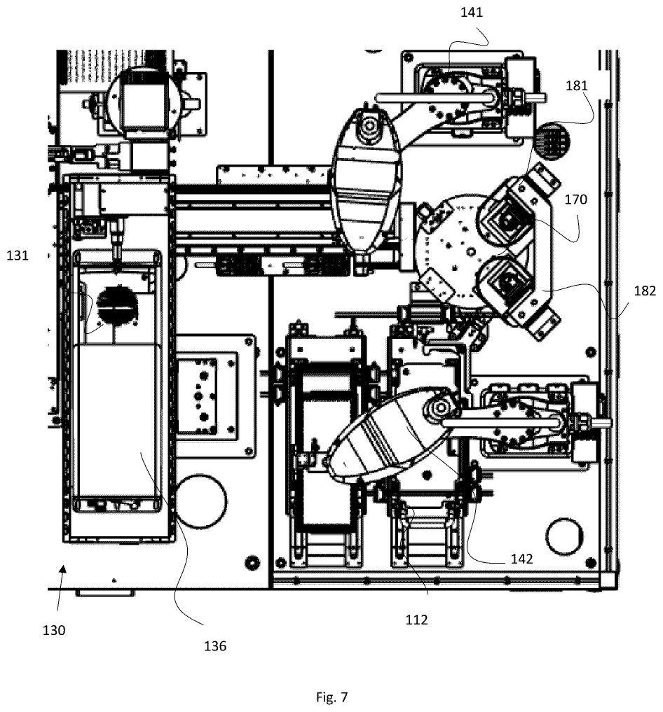

Attention shall now draw to FIG. 7 revealing the top view of the disclosed system (100) including part of the placing module (140) and the inspection module (180). As mentioned earlier, the placing module (140) essentially comprises the first robotic arm (141) and the second robotic arm (142) that the first (141) and second arms (142) are positioned substantially opposite to one another on the platform (110) with the rotary surface (170) and the cameras (181 and 182) located in between at a distance within the reach of the robotic arms (141 and 142). In more specific, the first robotic arm (141) picks the composite sheets (200) from the slicing tray (123) and transfer these composite sheets (200) onto an unblocked inspection slot on the rotary tray closest to the first camera (181). On the other hand, the second robotic arm (142) is fashioned to pick composite sheet (200) meeting the predetermined parameter out from an unblock inspection slot closest to the second camera (182). Those defective composite sheets (200) failing to meet the predetermined parameter are discarded later using the inspection module (180) in few embodiments of the disclosed system (100). Each of the robotic arms (141 and 142) may have a plurality of effectors, preferably 4 or more, to pick and place the composite sheets.

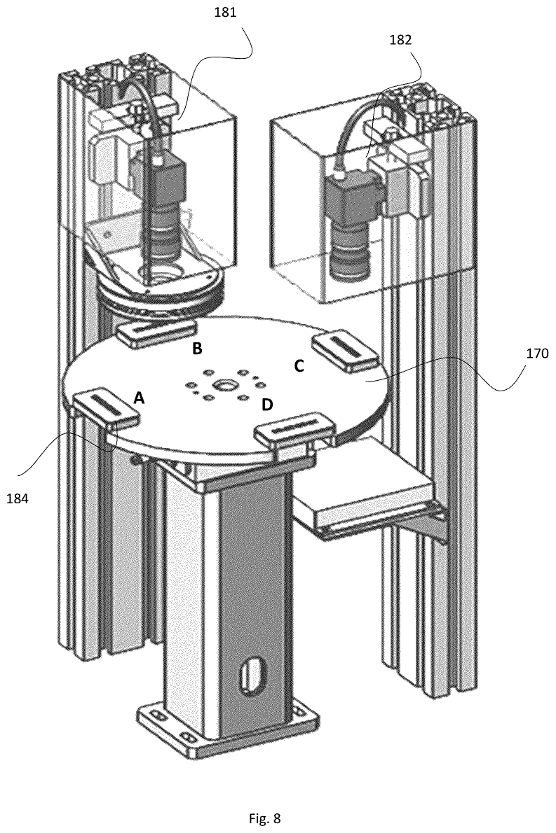

Details regarding the inspection module (180) can be seen in FIG. 8. Particularly, the rotary surface (170) is a substantially circular piece having a planar top surface on which the inspection slots (184) are constructed. In the embodiments shown in FIG. 8, there are four different inspection slots (184) rotatably moving towards four positions (A, B, C, D) in relative to the first (181) and second cameras (182) corresponding to turning to the rotary surface (170) in a complete circle. There are other embodiments which the cameras are shifted towards the position of the inspection slots along the horizontal plane for image capturing rather than rotating the rotary surface (170). The inspection slots are preferably arranged in a single or multiple rows. In some embodiments, each row preferably has even number of slots (184) that the first camera (181) captures a first image for half number of the composite sheets placed in the row and the second camera (182) capture another half number of the composite sheet of the same row. The inspection slots (184) are equally spaced apart around the edge of the rotary surface (170). In some embodiments, each slot (184) is carved on a block, which can be titled at an angle for removing the composite sheets (200) positioned within the defined inspection slot (184). At position A, the first robotic arm (141) fills the newly sliced composite sheets (200) into the inspection slot. The filled slot subsequently advances to position B that access to the inspection slot, by the robotic arm (141), at this position becomes blocked in the presence of the first camera (181). The first camera (181) takes an image, a first image, of the composite sheets (200) located at B. After capturing the first image, the rotary surface (170) brings the composite sheets (200) to position C for capturing a second image. The inspection slot is blocked from being accessed by the second robotic arm (142) in the presence of the second camera (182) at the position C. In some embodiments, the images are preferably taken with additional enhancement. For instance, one or more optic filter and/or magnification glass can be placed under the second camera (182) to acquire the enhanced image. The composite sheets (200) are moved from position C to position D after taking the second image. At position D, the second robotic arm (142) picks the composite sheets (200) meeting the predetermined parameters and moves them to storage. Upon completing picking of the composite sheets (200) with the acceptable quality, the disclosed may flip or tilt the block away from the rotary surface (170) at an angle sufficient to hurl or propel the defective composite sheets (200) out from the inspection slots (184) for disposal in several embodiments of the disclosed system (100). In general, the cameras or the P number of cameras are spaced apart and suspended on top of the rotary surface (170) that the rotary surface (170) rotates to align each divided zone with the corresponding camera for capturing digital image in a stepwise fashion.

Both first and second images preferably contains details of the contour profile of each composite sheets (200) for subsequent analysis conducted using the computing device. Based upon the information gathered from the first and second images, the parameters to be analysed comprises surface area of the available burn mark on the composite sheet (200), physical dimension of the composite sheet (200) and/or ratio of surface area on the composite sheet (200) contaminated by debris produced during the heating. More specifically, the images are analysed for degree of contamination, burnt, bending, etc. inflicted towards the composite sheets (200) during the cutting or slicing process. Also, the images are subjected to analysis for measuring various physical dimensions of the composite sheets and/or different features fabricated on the imaging surface of the composite sheets (200). For example, in an embodiment where four pieces of composite sheets (200) each being placed in a single row of inspection slots (184) of four. The first camera (181) takes a first image of a pair of the composite sheets located on the left of the row while the second camera (182) capture the second image of the pair of composite sheets positioned at the right side of the row. The first and second images captured will be sent to the computing module or device for further processing to identify any possible defects that may harm performance of the composite sheets (200). These images may be converted to grey scale image to facilitate the analysis for a number of embodiments. These defects can be any one or a combination of dent, contamination, burn, bend, etc. In some embodiments, the computing module is configured or trained to recognize an area of discoloration, reflection and/or image noise of the images of the composite sheets (200) captured exceeding a predetermined value, as a burn area or contaminated area. If the total burn area or contaminated area of a composite sheet shown in the image were identified to be exceeding a predetermined amount, the composite sheet (200) is considered defective and subsequently removed by the second robotic arm (142). As to measurement, a datum or several data positioned on the surface of the composite sheets (200) may be used by the computing module to derive or compute the corresponding value through the captured images. For instance, in edge measurement, the computing module is configured or trained to search all related edges defining outer shape of the composite sheet then determine one or more data or reference pints (in relation to vertical axis, horizontal axis and/or angle). It is important to note that the acceptable range for the composite sheets to deviate from the desired shape and size is about 1 to 200 μm, more preferably within the range of 5 to 50 μm such that the composite sheet can be implemented for its intended use. Therefore, the inspection, measurement, or automated optical inspection (A.O.I) performed by the disclosed system has to be on significantly high-resolution images captured through the first (181) and second cameras (182) for identifying the extremely small yet undesired defects on the sliced composite sheets (200). By splitting a batch of composite sheets to be inspected through two or more separated images utilizing corresponding two or more cameras, the disclosed system (100), particularly via the computing device, is able to process the images at high speed to substantially matching the rate of the composite sheets (200) being cut at the cutting module (130) overcoming potential hold-up associated with the image analysis for filtering out the defective composite sheets.

In accordance with further embodiments of the disclosed system (100), the computing device further comprises a user interface for an operator to control operation of one or more modules installed to the disclosed system (100) and/or adjust the predetermined parameters.

The present disclosure may be embodied in other specific forms without departing from its structures, methods, or other essential characteristics as broadly described herein and claimed hereinafter. The described embodiments are to be considered in all respects only as illustrative, and not restrictive. The scope of the disclosure is, therefore, indicated by the appended claims, rather than by the foregoing description. All changes that come within the meaning and range of equivalency of the claims are to be embraced within their scope.

1. A system for cutting composite sheets from a composite panel comprising
a platform defined by a top, a bottom and sidewalls;
a displacement module on the top of the platform, the displacement module comprising (i) a holder for retaining an uncut composite panel and a primary actuator arranged on the platform engaging to the holder in a manner facilitating transfer of the holder along with the retained panel, and (ii) at least a pair of slicing trays each with a planar surface for receiving the composite panel transferred thereto by the holder and a secondary actuator engaging to at least one of the pair of slicing trays;
a cutting module located on the platform for slicing a plurality of the composite sheets from the composite panel, which is kept within the slicing tray, by way of heating the composite panel at specific locations using a laser beam generated from a laser which moves on top of the composite panel at a predetermined fashion in multiple working sequences, each moving sequence of the laser being configured to slice N copy of the composite sheet, each composite sheet having a contour profile, wherein the laser is an ultrashort pulse laser capable of emitting ultrashort pulses of laser beam in an order of nanosecond to picosecond,
wherein the composite panel is a laminate comprising at least a polyethylene layer, an electroplated layer, and a conductive metal layer with the electroplated layer sandwiching in between the polyethylene layer and the conductive metal layer.

2. The system of claim 1 further comprising a placing module comprising a first robotic arm and a second robotic arm each being configured to pick a Y number of the sliced composite sheets from the slicing tray and arrange each of the picked composite sheets onto one of multiple inspection slots located on a rotary surface; and
an inspection module comprising a P number of cameras each being enabled to respectively capture a digital image comprising the contour profile of at least one composite sheet at one of the inspection slots and a computing device to process the digital image for a computing device to analyse the contour profile using a set of predefined parameters, the first and second robotic arms being configured to collect the composite sheets meeting the parameter, where in Y and P are more than one.

3. The system of claim 2 further comprising a loading bay for housing multiple composite panels arranged in stack.

4. The system of claim 3 further comprising an alignment module having a slab being configured to receive the composite panel from the loading bay through the holder and align the received composite panel thereby in accordance with a predetermined setting.

5. The system of claim 4, wherein the slab is slant towards an angle along with the composite panel for aligning the composite panel in accordance with the predetermined setting.

6. The system of claim 4 further comprising a first sensor to detect and read at least a code carried on the composite panel that the holder moves a topmost composite panel from the stack in the loading bay to the slab upon verification of the code by the computing device and the code is associated with information regarding qualitative measurements of the composite panel.

7. The system of claim 2, wherein the Y number of the sliced composite sheets placed in the inspection slots are divided into P number of zones that digital image of composite sheets of each divided zone is captured respectively by one of the P number of cameras.

8. The system of claim 7, wherein the cameras are spaced apart and suspended on top of the rotary surface that the rotary surface rotates to align each divided zone with the corresponding camera for capturing digital image in a step-wise fashion.

9. The system of claim 2, wherein the slicing tray carries a plurality of apertures on the planar surface of the slicing tray with a constant flow of negative air pressure generated such that a suction force is created to pull the sliced composite sheets towards the planar surface and/or cool the composite panel.

10. The system of claim 9, wherein the suction force removes debris produced from the slicing of the composite sheets by the laser through the plurality of apertures.

11. The system of claim 2, wherein the cutting module further comprises a secondary sensor capable of capturing or recognizing N number of individual fiducial marker, each for a composite sheet, on the composite panel that the computing device computes positional and angular compensation associated to the working sequence in moving the laser for slicing the composite sheets based upon the recognized N number of individual fiducial marker.

12. The system of claim 11, wherein N ranges between 2 to 50.

13. The system of claim 2, wherein the pair of slicing trays have one of the slicing trays subjected to heating for slicing the composite sheets while another slicing tray subjected the sliced composite sheets to picking by the robotic arms.

14. The system of claim 2, wherein the holder is configured to place a cover plate onto the composite panel prior to slicing of the composite panel that the laser beam scribe through the cover plate along with the underneath composite panel to produce the composite sheets.

15. The system of claim 2, wherein the parameter comprises surface area of the available burn mark on the composite sheet, physical dimension of the composite sheet and/or ratio of surface area on the composite sheet contaminated by debris produced during the heating.
